(19) United States
(12) Patent Application Publication
(10) Pub. No.: US 2014/0361128 A1
(43) Pub. Date: Dec. 11, 2014

(54) Support Bracket and Screen and Assemblies and Accessories for the Use Therewith

(71) Applicant: Herman Miller, Inc., Zeeland, MI (US)

(72) Inventors: Claudia Plikat, Berlin (DE); Johann Burkhard Schmitz, Berlin (DE); Carola Eva Marianne Zwick, Berlin (DE); Roland Rolf Otto Zwick, Berlin (DE); Janja Maidl, Berlin (DE)

(73) Assignee: Herman Miller, Inc., Zeeland, MI (US)

(21) Appl. No.: 14/298,354

(22) Filed: Jun. 6, 2014

Related U.S. Application Data
(60) Provisional application No. 61/832,617, filed on Jun. 7, 2013.

(51) Int. Cl. F16M 13/02; A47F 7/00; F16M 11/00

(52) U.S. Cl. CPC F16M 13/022; F16M 11/00; A47F 7/0042
USPC 248/126

(57) ABSTRACT

A support bracket includes a first vertically extending leg defining a mounting portion, a second vertically extending leg horizontally spaced apart from the first leg, and a third vertically extending leg horizontally spaced apart from the first and second legs. A connector extends horizontally between and connects the first leg and the second leg, and the first leg and the third leg. The first, second and third legs extend downwardly from a lower surface of the connector. A support accessory may be coupled to the mounting portion. A screen, including a plurality of vertically elongated supports, is also provided.

This application claims the benefit of U.S. Provisional Application Ser. No. 61/832,617, filed Jun. 7, 2013, the entire disclosure of which is hereby incorporated herein by reference.

### FIELD OF THE INVENTION

The invention relates to various support brackets and assemblies, screens and to various accessories that may be used therewith.

### BACKGROUND

Partition systems, such as that disclosed in U.S. Patent Publication No. 2012/0159869, entitled “Partition System,” the entirety of which is hereby incorporated herein by reference, have been developed to divide and define various workspaces. In some embodiments, the partition system includes a plurality of wall elements merging one into another. Some of the wall elements may be linear, while others may be curved. This variation in shape may make it more difficult to accommodate and support various furniture components and accessories thereon, including various worksurfaces, backdrops, shelving and storage arrangements, power supply and the like. Thus, the need remains for various accessories that may be adapted for use with curved and linear wall elements, and which may be located at any location along the length of the wall.

### SUMMARY

In one aspect, one embodiment of a support bracket includes a first vertically extending leg defining a mounting portion, a second vertically extending leg horizontally spaced apart from the first leg, and a third vertically extending leg horizontally spaced apart from the first and second legs. A connector extends horizontally between and connects the first leg and the second leg, and the first leg and the third leg. The first, second and third legs extend downwardly from a lower surface of the connector.

In another aspect, one embodiment of a support bracket assembly includes a support accessory having a second mounting portion removably coupled to the first mounting portion of the support bracket. In one embodiment, the first mounting portion is a socket, while the second mount portion is a post. In other embodiments, the first mounting portion is a post, while the second mounting portion is a socket.

In yet another aspect, the support bracket straddles a wall, with the first leg being disposed on one side of the wall, and the second and third legs being disposed on the other side. In various embodiments, the wall, the first and second sides thereof, may be curved or linear.

In another aspect, a method of installing a support bracket on a wall includes providing a connector having a first arm extending horizontally between and connecting the first leg and the second leg, and a second arm extending horizontally between and connecting the first leg and the third leg. The method includes bending at least one of the first and second arms, positioning the first leg adjacent a first side of a wall, positioning the second and third legs adjacent a second side of the wall, and releasing the at least one of the first and second arms.

In another aspect, one embodiment of a screen includes a plurality of elongated supports each having a mounting portion disposed adjacent one end of the elongated support and an opposite distal end portion vertically spaced from the mounting portion. The mounting portion includes a claw opening downwardly away from the distal end portions. A plurality of flexible joints connects the mounting portions and the distal end portions intermediate the mounting portions and the distal end portions, wherein the plurality of elongated supports may be arranged in a linear or curved configuration. In various embodiments, the mounting portions may be configured with opposed fingers, which may be joined along a distal end thereof.

The various aspects and embodiments provide significant advantages over other support brackets and assemblies. For example and without limitation, the support bracket can be easily located on top of a wall without any extra fasteners or the like. Moreover, the support bracket can be positioned at infinite locations along the wall. The modular interface also allows for various and different support accessories to be supported by the same support bracket, thereby improving the versatility of the system, while eliminating the need to maintain additional components in inventory. In addition, the support brackets may be installed on linear or curved walls.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1 is a perspective view of a support bracket.

FIG. 2 is a front view of the support bracket shown in FIG. 1.

FIG. 3 is a top view of the support bracket shown in FIG. 1.

FIG. 4 is a cross-sectional view of the support bracket taken along line 4-4 of FIG. 2.

FIG. 5 is a perspective view of a support accessory.

FIG. 6 is a front view of the support accessory shown in FIG. 5.

FIG. 7 is a cross-sectional view of the support accessory taken along line 7-7 of FIG. 6.

FIG. 8 is a top view of the support accessory shown in FIG. 5.

FIG. 9 is a perspective view of a linear wall element.

FIG. 10 is a perspective view of a curved wall element.

FIG. 11 is side view of an alternative embodiment of a support bracket.

FIG. 12 is a side view of an alternative embodiment of a support accessory.

FIG. 13 is a perspective view of one embodiment of a support accessory.

FIG. 14 is a perspective view of another embodiment of a support accessory.

FIG. 15 is a perspective view of the support bracket being installed on a wall.

FIG. 16 is a perspective view of a support accessory supported by a pair of support brackets mounted on a wall.

FIG. 17 is a perspective view of a support accessory supported by a support bracket mounted on a wall.

FIG. 18 is a plan view of a pair of support brackets mounted on a wall.

FIG. 19 is a perspective view of alternative support brackets mounted on a wall.

FIG. 20 is an exploded perspective view of one embodiment of a support accessory.

FIG. 21 is a side view of a support bracket mounted on a wall and a support accessory.

FIG. 22 is a perspective view of a screen mounted on a wall.

FIG. 23 is a front view of the screen shown in FIG. 22.

FIG. 24 is a rear view of the screen shown in FIG. 22.

FIG. 25 is a perspective view of the screen shown in FIG. 22.

FIG. 26 is a partial perspective view of a plurality of devices supported by a support accessory and support bracket on a wall.

### DETAILED DESCRIPTION OF THE PRESENTLY PREFERRED EMBODIMENTS

### General:

The term “longitudinal” as used herein is intended to indicate a lengthwise direction, for example of a wall, leg or arm. Similarly, the terms “front”, “side”, “back”, “forwardly”, “rearwardly”, “upwardly” and “downwardly” as used herein are intended to indicate the various directions and portions of the wall and support bracket or accessory coupled thereto as normally understood when viewed from the perspective of a user facing the wall and interfacing with the bracket and accessories. It should be understood that the terms “vertical” and “horizontal” refer to the orientation of the element or component in a position of normal usage. It should be understood that the terms “mounted,” “connected”, “coupled,” “supported by,” and variations thereof, refer to two or more members or components that are joined, engaged or abutted, whether directly or indirectly, for example, by way of another component or member, and further that the two or more members, or intervening member(s) can be joined by being integrally formed, or by way of various fastening devices, including for example and without limitation, mechanical fasteners, adhesives, welding, press fit, bent-over tab members, etc. The term “plurality” means two or more. The terms “curved” and “linear” refer to the shape or configuration of a particular element or component in a plane view when being viewed from above, with “linear” being interchangeable with “straight.” It should be understood that the use of numerical terms “first,” “second,” “third,” etc., as used herein does not refer to any particular sequence or order of components; for example “first” and “second” legs may refer to any sequence of such components, and is not limited to the first and second components of a particular configuration unless otherwise specified.

### Wall Elements:

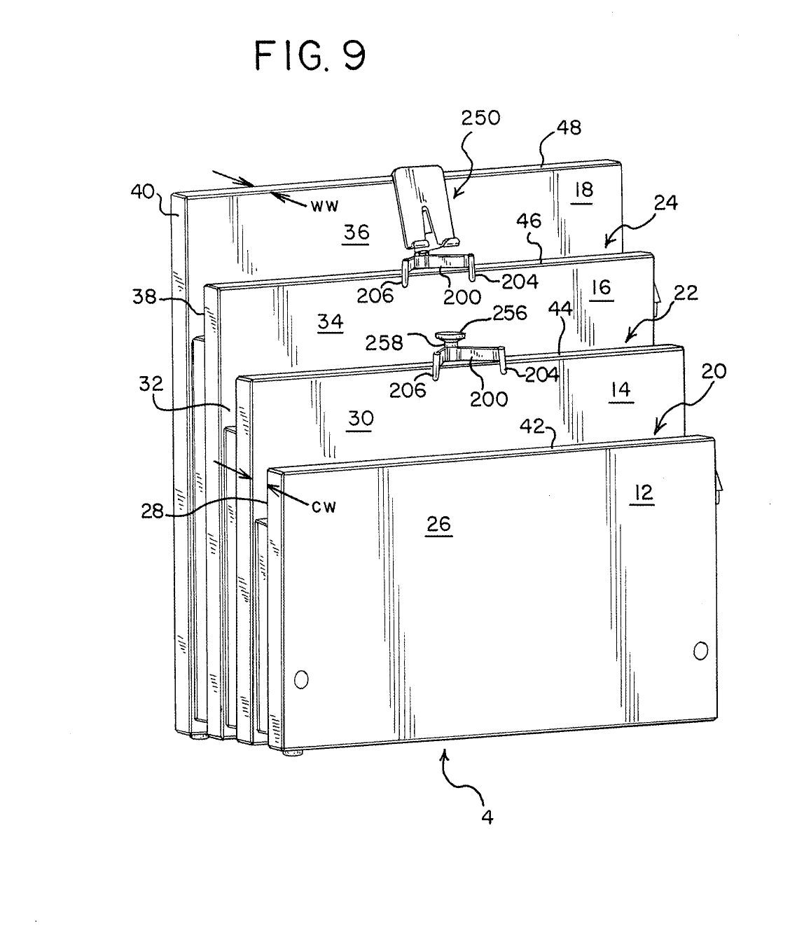

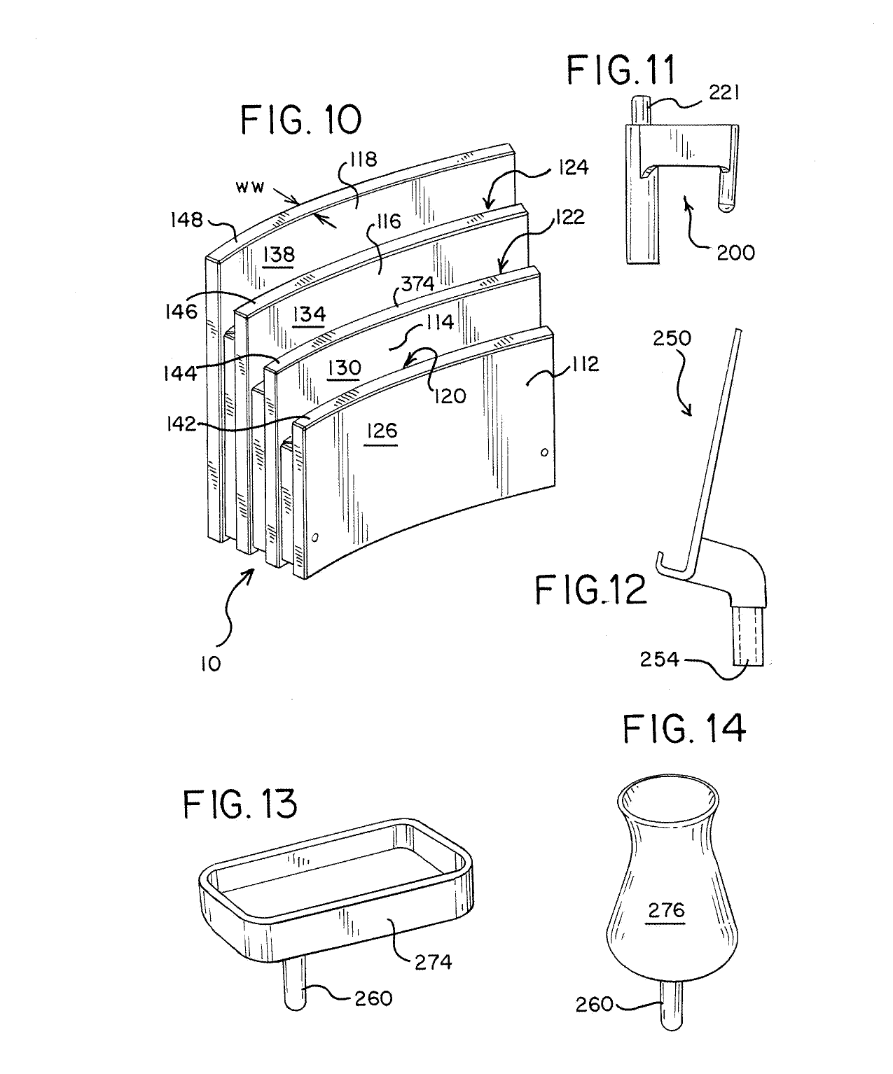

Referring to FIGS. 9 and 10, wall elements 4, 10 are shown as being curved or linear elements. In one embodiment, the wall elements 4, 10 are configured as stepped element, which defines a plurality of walls 12, 14, 16, 18, 112, 114, 116, 118 arranged at different heights, and a plurality of channels 20, 22, 24, 120, 122, 124 arranged at different heights. Each of the walls 12, 14, 16, 18, 112, 114, 116, 118 has opposite sidewalls 26, 28, 30, 32, 34, 36, 38, 40, 126, 128, 130, 132, 134, 136, 138, 140 defining a width (WW) of the respective wall and a top, or upper support surface 42, 44, 46, 48, 142, 144, 146, 148. Likewise, each of the channels 20, 22, 24, 120, 122, 124 has a bottom 50, 52, 54, 150, 152, 154 and opposite sidewalls 28, 30, 32, 34, 36, 38, 128, 130, 132, 134, 136, 138 defining a width (CW) of the channel. Pairs of walls define the channels therebetween, with the sidewalls of spaced apart walls corresponding to the sidewalls of the channel formed therebetween. In one embodiment, the wall elements are configured with four walls and three channels, although it should be understood that more or less walls and channels may be used. In various embodiments, the heights HW1, HW2, HW3, and HW4 of the walls 12, 14, 16, 18, 112, 114, 116, 118 are 42 inches, 35.5 inches, 29.00 inches and 22.5 inches respectively in one embodiment, and 41.625 inches, 35.312 inches, 29.00 inches and 22.69 inches respectively in another embodiment, while the height of the bottom 50, 52, 54, 150, 152, 154 of the channels HC1, HC2 and HC3 are 31.16 inches, 24.85 inches and 18.54 inches respectively, although other heights may be suitable. The depth of the channels (height of front wall to bottom of channel) may be calculated, and is about 4.5 inches in one embodiment. In addition, the walls may have linear sides as shown, or may be tapered. The width (CW) of the channels 20, 22, 24, 120, 122, 124 is 2.00 inches, and preferably between 1 and 10 inches, while the width (WW) of the walls 12, 14, 16, 18, 112, 114, 116, 118 is also 2.00 inches, and preferably between 1 and 10 inches. It should be understood that other heights and widths may be suitable. Preferably, the widths of the walls are the same such that they are suited to support similar components, but varying widths may be employed. Likewise, the widths of the channels are the same to support similarly shaped and dimensioned components, but the widths may vary as deemed appropriate.

The wall elements 4, 6, 8, 10 have opposite end surfaces 56, 58, 156, 158, which are abutted during assembly. Each wall element, otherwise referred to as a furniture “base,” may be made of EPP plastic. Of course, the wall element may be made of other materials, such as wood, metal, particle board, fiber materials, etc., and combinations thereof. Moreover, the wall element may be configured as a single wall.

### Adjustable Screen:

Referring to FIGS. 19 and 21-25, an adjustable screen 70 is shown as including a plurality of vertically elongated supports 72, each having a front surface 82. Each support 72 includes a mounting portion 74 formed at one end thereof and an opposite distal end portion 76. In one embodiment, the mounting portion 74 is configured as a claw having a base and opposing fingers 80, 86 defining a downwardly opening channel 81. The width of the channel 81 is sized to receive one of the walls 12, 14, 16, 18, 11, 114, 116, 118 with a snug fit. The fingers 80 are longer than the fingers 86, and may extend into the channel formed by the wall element. The ends of the fingers 86 are joined in one embodiment by a bridge 88 element that increase the overall stability of the mounting portion. The distal end 76 is vertically spaced from the mounting portion and the top of the wall on which the screen is mounted. The mounting portion and distal portion of each elongated support are joined along an intermediate location between the mounting end and the distal free end with a flexible joint 78. Each mounting portion, except a pair of bookend mounting portions 84, are joined to a pair of distal end portions with a pair of flexible joints 78, and conversely, each distal end portion 76 is joined to a pair of mounting portions with a pair of flexible joints. The mounting portions 84 are connected to a single distal end portion 76 via a flexible joint 78. In this way, the screen is configured with a plurality of elongated serpentine loops.

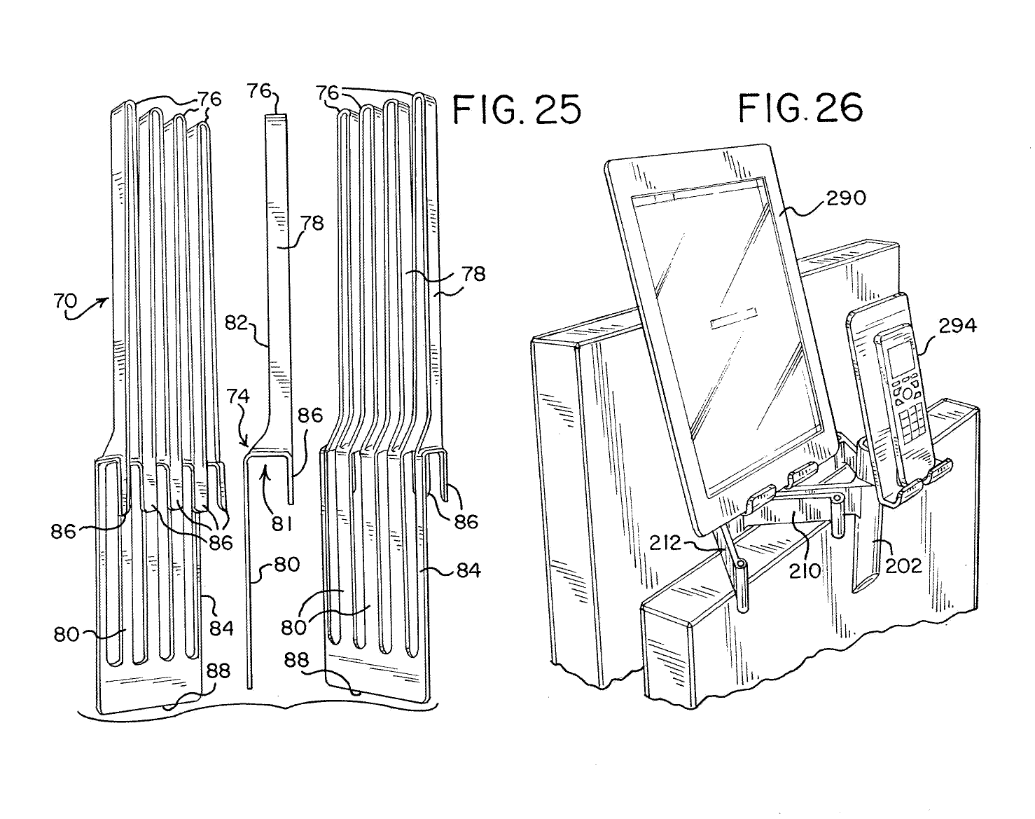

In one embodiment, the flexible joint 78 is configured as an elongated flexible strip that allows relative rotation through torsion about a vertical axis between the supports, with the either the mounting portions 74 or the distal end portions 76 being rotated relative to each other, depending on whether the wall is curved concavely or convexly. In this way, the supports 72 may configured with their mounting portions forming a linear channel (FIG. 25) for engagement with a linear wall, or with the mounting portions forming a curved channel for engagement with a curved wall. In the latter configuration, the screen forms a segment about a virtual center spaced from the wall and support bracket. The screen may be made of ABS plastic.

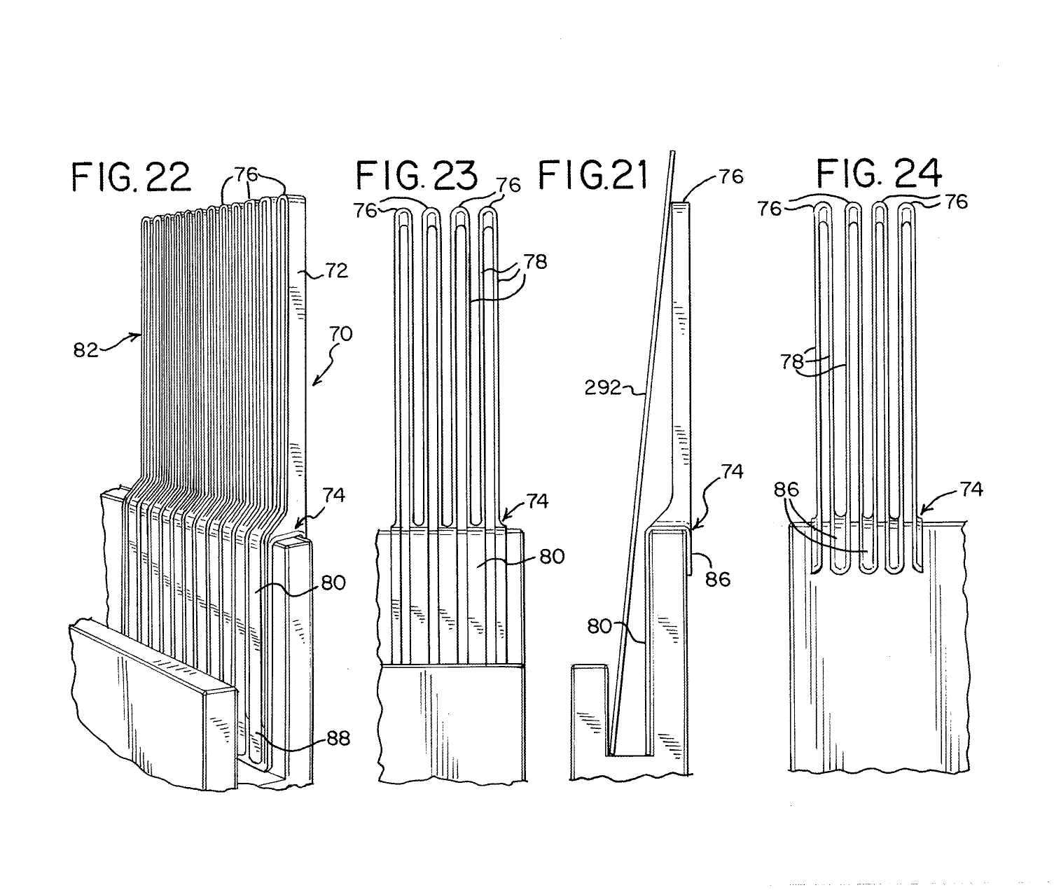

The screen may provide a visual barrier and extension to the wall. In addition, as shown in FIG. 21, the screen may provide a back-stop or support for a backdrop, such as viewing board. The term “backdrop” refers to any type of screen or display, whether vertically self-supporting or supported by an internal or external frame. The front surface 82 may be set back horizontally from the fingers 80 so as to provide of a space for the backdrop to angle rearwardly against the screen. The backdrop may be made of wood, metal, plastic (e.g. acrylic), fiberglass, or other known and suitable materials, or combinations thereof, and may be covered (e.g., fabric) or uncovered. In one embodiment the backdrop is configured with an erasable whiteboard surface. The backdrop may function as a display surface for a projected image, whether from the front or back thereof. The backdrop may be planar (linear) or curved.

### Support Bracket and Accessories:

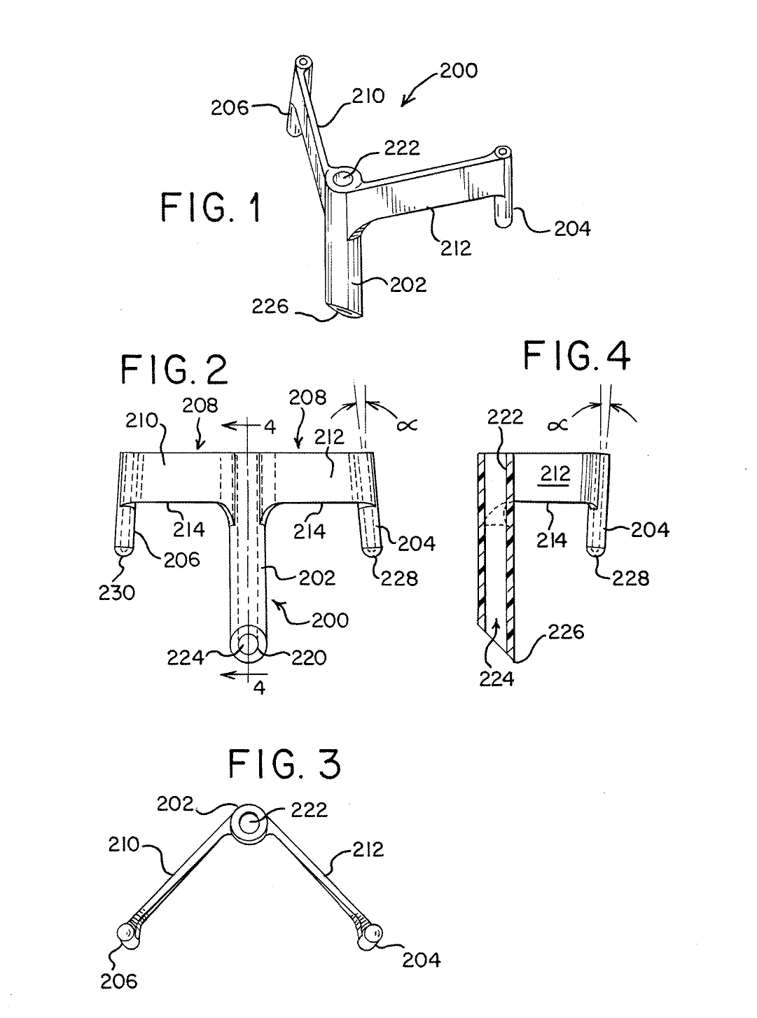

Referring to FIGS. 1-4, 9, 11 and 14-19, a support bracket 200 includes a first vertically extending leg 202 defining a mounting portion 220, a second vertically extending leg 204 horizontally spaced apart from the first leg, and a third vertically extending leg 206 horizontally spaced apart from the first and second legs. A connector 208 extends horizontally between and connects the first leg 202 and the second leg 204, and the first leg 202 and the third leg 206. The first, second and third legs extend downwardly from a lower, or lowermost, surface 214 of the connector. In one embodiment, the connector includes a first horizontally extending arm 212 connecting the first and second legs and a second horizontally extending arm 210 connecting the first and third legs. The arms 210, 212 have a greater height than width so as to promote greater bending flexibility about a vertical axis and greater relative stiffness about a horizontal axis. As mentioned, the first and second legs extending downwardly from a lower, or lowermost, surface of the first and second arms. In one embodiment, the first and second arms 210, 212 form a substantially right angle therebetween. In other embodiments, the angle between the arms when viewed from a plan view is between about 120 degrees and 60 degrees. As shown in FIGS. 2 and 4, the second and third legs 204, 206 are non-parallel to the first leg 202, and to each other, forming an angle α between 0 and 20 degrees. It should be understood that the connector may be configured as a plate connecting the first and second and third legs, or as other non-linear arms, whether curved or multi-segmented.

Referring to FIGS. 1-4, the mounting portion 220 includes a socket 222 having an opening 224 extending therethrough. In alternative embodiment, shown in FIG. 11, the mounting portion includes an upwardly extending post 221. The first leg, or mounting portion, has a lower end 226 spaced below the lower ends 228, 230 of the second and third legs, the latter of which may be rounded to facilitate installation on a wall. The first leg may include a tapered lower end 226. The second and third legs may also have openings extending therethrough.

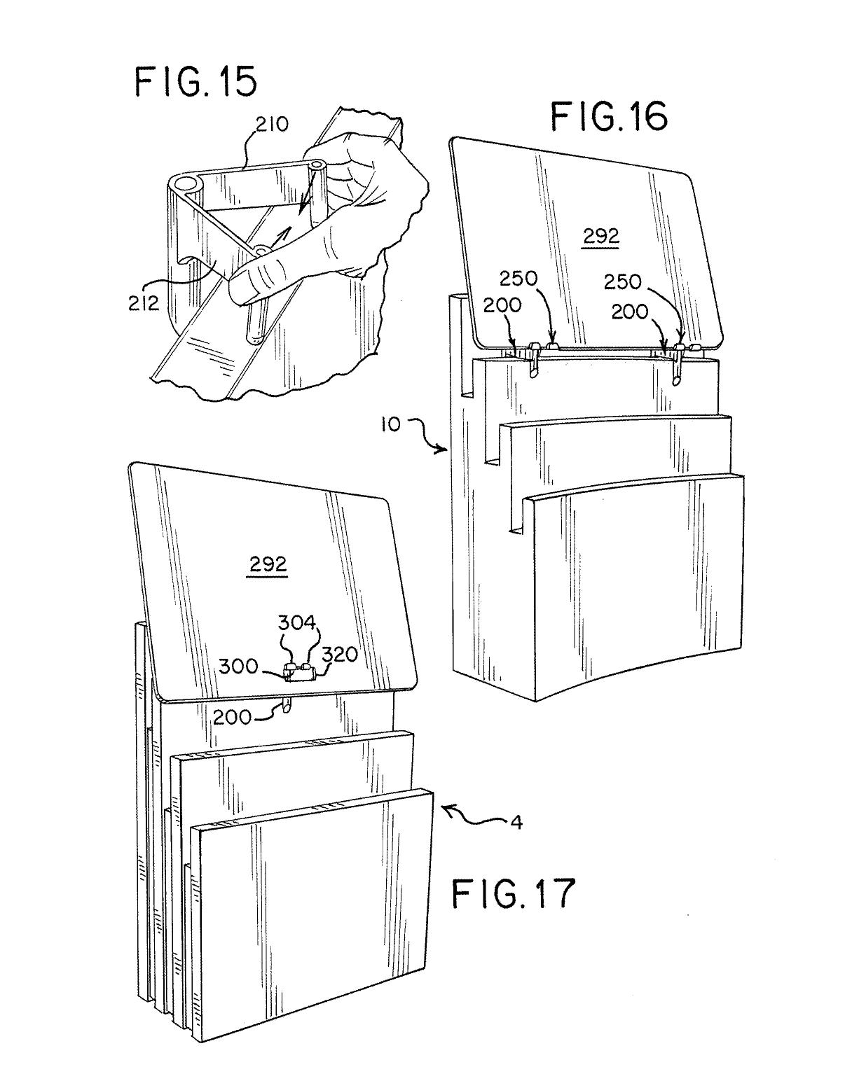

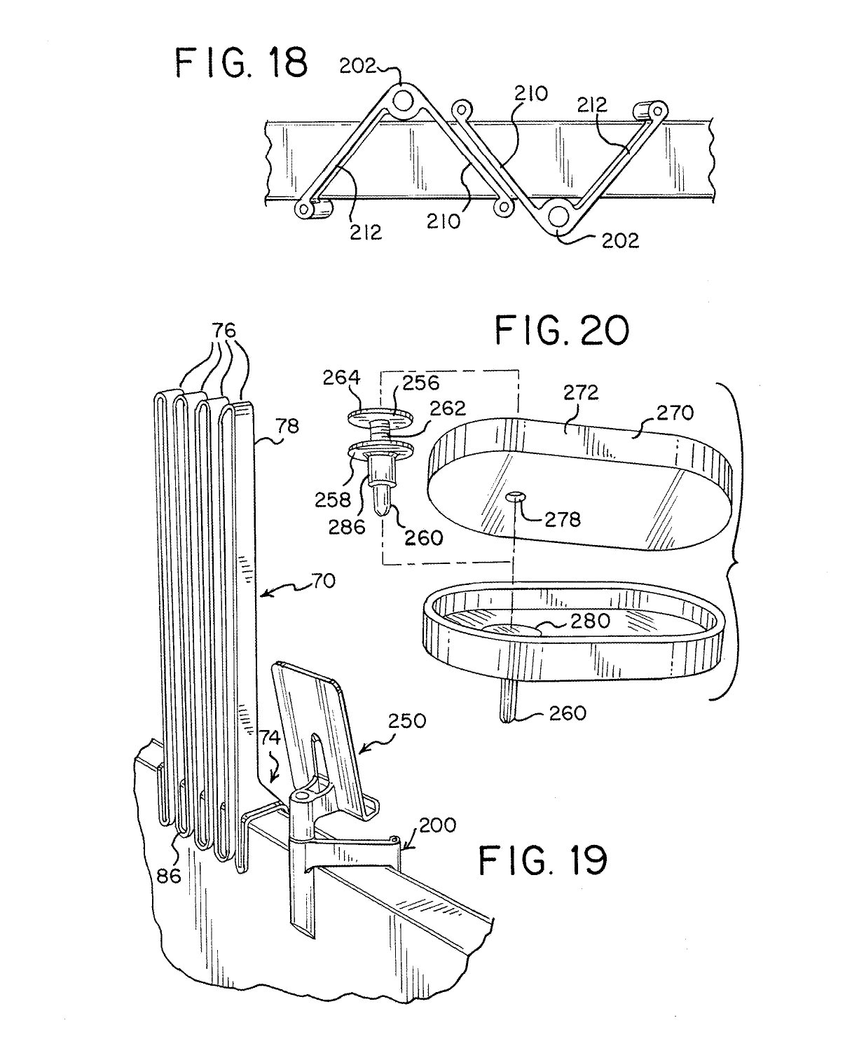

To install the bracket on a wall, a user, or installer, bends one or both of the first and second arms 212, 210 as shown in FIG. 15, and thereafter disposes the first leg 202 adjacent a first side of the wall and the second and third legs 204, 206 adjacent a second side the wall, which wall and sides may be linear or curved. In essence, the wall is positioned between the downwardly extending portions of the first leg and the second and third legs, with the arms, or lower surfaces 214 thereof, resting or being positioned above the top of the wall and the bracket straddling the wall. The user may then release the first and/or second arm, such that the legs 202, 204, 206 engage the opposite sides of the wall. As shown in FIG. 18, a pair of support brackets 200 may be mounted on the wall with the first legs, and mounting portions thereof, being positioned on opposite sides of the wall, and with the arms 212, 210 being nested and running parallel to each other.

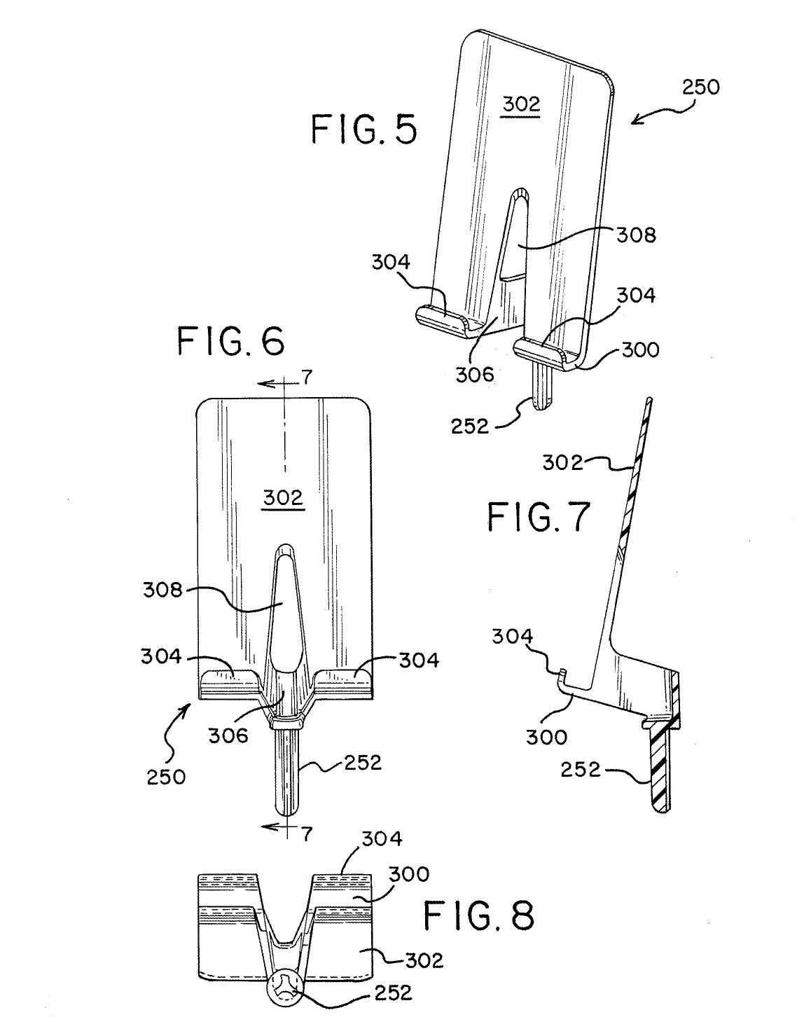

Referring to FIGS. 5-9, 12-15, 16, 17, 19 and 20, a support bracket assembly includes a support accessory 250 having a second mounting portion 252 removably coupled to the first mounting portion of the support bracket. In one embodiment, the second mounting portion is a post, which may have a cylindrical, square, triangular, X-shaped or star-shaped cross-section, or any other suitable cross-section, with the post being received in the socket of the first mounting portion on the bracket. In other embodiments, shown in FIG. 12, the second mounting portion is a socket 254 which receives the post of the first mounting portion.

In one embodiment, and referring to FIG. 20, the second mounting portion includes a screw 256 and a nut 258. The screw 256 includes an upper threaded portion 262 and a lower post portion 260, shaped to be received in the socket of the first mounting portion. A support accessory 270, such as a container, shown as a tray 272 in FIG. 20, a box 274 in FIG. 13, and a vase 276 in FIG. 14, includes an opening 278, together with a recess 280 formed in an upper surface thereof. The recess 280 is dimensioned and shaped to receive a head 264 of the screw, with the top of the head 265 then lying flush with a bottom surface of the support accessory. The nut 258 is disposed adjacent a bottom surface of the support accessory 270, with the screw 256 extending through the opening and the threaded portion 262 threadably engaging the nut 258. The nut 258 may include ribs or channels 286 or another grippable portion, allowing the nut to be snuggly tightened, with the support accessory sandwiched between and secured by the screw and nut. The post 260 of the screw may then be inserted into the socket 222 of the first mounting portion, or a socket 254 formed on the screw inserted onto a post 221, to complete the assembly.

Referring to FIGS. 5-9, 19 and 26, one embodiment of the support accessory 250 is configured as a cradle, which is shaped and adapted to support one or more of a tablet device 290, hand-held device 294, backdrop 292, book, paper or other similar items. The cradle includes a mounting portion 252, configured as a post, a shelf 300 and a back support 302 extending upwardly and rearwardly from the shelf 300, while the shelf also is angled upwardly relative to a horizontal plane. A lip 304 is formed along a front of the shelf opposite the back support. The lip may be split into two portions, with a space or groove 306 formed therebetween to provide a wire raceway in front of the cradle. In addition, an opening 308 is formed through the backs support to provide an alternative wire raceway.

In operation, as shown in FIG. 26, a tablet device 290 is supported by a first cradle connected to a first support bracket, while a handheld device 294 is supported by a second cradle on second support bracket, with the support brackets nested with mounting portions positioned on opposite sides of the wall as shown in FIG. 18. Wires from the devices 290, 294 may be routed through one of the raceways 306, 308. In yet another embodiment, a single cradle 250 supports a backdrop 292 as shown in FIG. 17, with the shelf 300 and lip 304 extending through a handle opening 320, although the shelf and lip may also support a lower edge thereof. As shown in FIG. 16, a pair of cradles 250 support a linear backdrop 292 on a curved wall, with the cradles, and coupled support brackets being spaced along a length of the wall. It should be understood that the modular support brackets may accommodate any number of support accessories, including without limitation the disclosed cradles and containers.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

1. A support bracket comprising:
a first vertically extending leg defining a mounting portion;
a second vertically extending leg horizontally spaced apart from said first leg;
a third vertically extending leg horizontally spaced apart from said first and second legs; and
a connector extending horizontally between and connecting said first leg and said second leg, and said first leg and said third leg, wherein said first, second and third legs extend downwardly from a lower surface of said connector.

2. The support bracket of claim 1 wherein said connector comprises a first horizontally extending arm connecting said first and second legs, wherein said first and second legs extend downwardly from a lower surface of said first arm; and a second horizontally extending arm connecting said first and third legs, wherein said first and third legs extend downwardly from a lower surface of said second arm.

3. The support bracket of claim 2 wherein said first and second arms form a substantially right angle therebetween.

4. The support bracket of claim 1 wherein said second and third legs are non-parallel to said first leg.

5. The support bracket of claim 1 wherein said first leg has a lower end spaced below lower ends of said second and third legs.

6. The support bracket of claim 1 wherein said mounting portion comprises a socket.

7. The support bracket of claim 6 wherein said mounting portion comprises an opening extending therethrough.

8. The support bracket of claim 1 wherein said second and third legs have rounded lower ends.

9. A support bracket assembly comprising:
a support bracket comprising:
a first vertically extending leg defining a first mounting portion;
a second vertically extending leg horizontally spaced apart from said first leg;
a third vertically extending leg horizontally spaced apart from said first and second legs; and
a connector extending horizontally between and connecting said first leg and said second leg, and said first leg and said third leg, wherein said first, second and third legs extend downwardly from a lower surface of said connector; and
a support accessory comprising a second mounting portion removably coupled to said first mounting portion.

10. The support bracket assembly of claim 9 wherein said connector comprises a first horizontally extending arm connecting said first and second legs, wherein said first and second legs extend downwardly from a lower surface of said first arm; and a second horizontally extending arm connecting said first and third legs, wherein said first and third legs extend downwardly from a lower surface of said second arm.

11. The support bracket assembly of claim 10 wherein said first and second arms form a substantially right angle therebetween.

12. The support bracket assembly of claim 9 wherein said second and third legs are non-parallel to said first leg.

13. The support bracket assembly of claim 9 wherein said first leg has a lower end spaced below lower ends of said second and third legs.

14. The support bracket assembly of claim 9 wherein said first mounting portion comprises a socket, and wherein said second mounting portion comprises a post removably received in said socket.

15. The support bracket assembly of claim 14 wherein said first mounting portion comprises an opening extending therethrough.

16. The support bracket assembly of claim 9 wherein said second and third legs have rounded lower ends.

17. The support bracket assembly of claim 9 wherein said support accessory comprises a container coupled to said second mounting portion.

18. The support bracket assembly of claim 9 wherein said support accessory comprises a cradle.

19. The support bracket assembly of claim 18 wherein said cradle comprises a shelf and a back support extending upwardly from said shelf.

20. The support bracket assembly of claim 19 wherein said cradle further comprises a lip formed along a front of said shelf opposite said back support.

21. A support bracket assembly comprising:
a wall having a top and opposite first and second sides;
a support bracket comprising:
a first vertically extending leg defining a first mounting portion, wherein said first leg is disposed on said first side of said wall;
a second vertically extending leg horizontally spaced apart from said first leg, wherein said second leg is disposed on said second side of said wall;
a third vertically extending leg horizontally spaced apart from said first and second legs, wherein said third leg is disposed on said second side of said wall; and
a connector extending horizontally between and connecting said first leg and said second leg, and said first leg and said third leg, wherein said first, second and third legs extend downwardly from a lower surface of said connector, wherein said connector is disposed over said top of said wall; and
a support accessory comprising a second mounting portion removably coupled to said first mounting portion.

22. The support bracket assembly of claim 21 wherein said first and second sides of said wall are curved.

23. The support bracket assembly of claim 21 wherein said first and second sides of said wall are linear.

24. The support bracket assembly of claim 21 wherein said connector comprises a first horizontally extending arm connecting said first and second legs, wherein said first and second legs extend downwardly from a lower surface of said first arm; and a second horizontally extending arm connecting said first and third legs, wherein said first and third legs extend downwardly from a lower surface of said second arm.

25-40. (canceled)
